(19) United States
(12) Patent Application Publication
(10) Pub. No.: US 2009/0059745 A1
(43) Pub. Date: Mar. 5, 2009

(54) OPTICAL PICKUP DEVICE AND INFORMATION RECORDING/PLAYBACK APPARATUS

(75) Inventor: Ikuya Kikuchi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 11/910,375

(22) PCT Filed: Feb. 28, 2006
(86) PCT No.: PCT/JP2006/303689

§ 371 Date: Oct. 1, 2007

(30) Foreign Application Priority Data
Mar. 30, 2005 (JP) 2005-096609

(51) Int. Cl. G11B 7/00

(52) U.S. Cl. 369/44.32; G9B/7

(57) ABSTRACT

The present invention provides an optical pickup device and an information recording/playback apparatus capable of correcting aberration of an optical beam in correspondence with a plurality of recording formats of optical disks while realizing miniaturization of the device and the apparatus and reduction in manufacturing cost.

A collimator lens (161) is disposed on an optical axis in correspondence with a BD. By moving the collimator lens (161) in a direction parallel with the optical axis, spherical aberration is corrected in accordance with the BD. A collimator lens (162) is disposed on an optical axis in correspondence with a CD and a DVD. By moving the collimator lens (162) in a direction parallel with the optical axis, spherical aberration is corrected in accordance with the CD and DVD. The collimator lenses are integrally held by a lens holder (163). A step motor (164) moves the lens holder (163) so that the collimator lenses (161, 162) move in directions parallel with the optical axes.

### TECHNICAL FIELD

The present invention relates to the technical field of an optical pickup device and an information recording/playback apparatus used for recording/playing back information to/from an optical recording medium such as an optical disk.

### BACKGROUND ART

In recent years, recording density is rapidly improved in the field of an optical disc such as CD (Compact Disc) and DVD (Digital Versatile Disc). Recently, an optical disc for recording and playing back data with a blue laser beam (wavelength 405 nm) (for example, BD (Blue-ray Disc) and “HDDVD (trademark)”) is standardized. On the other hand, even though an optical disc having a new recording format appears, considerably long time is expected to completely replace the old optical discs with new optical discs. It is expected that CDs and DVDs are widely used also in future. In view of such circumstances, it is a big issue how to record/playback information to/from optical discs (for example, CD, DVD, and BD) compatible with a plurality of recording formats by a single apparatus, that is, how to realize compatibility.

As one of methods for realizing an information recording/playback apparatus having the compatibility (so-called compatible recorder), independent optical pickup devices for the respective recording formats are provided and, according to the kind of an optical disc to be recorded/played back, the optical pickup device used is switched. Such a method, however, causes problems of rise in manufacturing cost of the apparatus and increase in the size of the apparatus and cannot be regarded as a realistic option.

From the viewpoint, hitherto, for example, Japanese Unexamined Patent Application Publication No. 2000-048373 discloses a method of realizing recording/playback of information to/from optical disks compatible with various recording formats by condensing an optical beam emitted from any of two light sources in accordance with an optical disk to be recorded/played back by any one of two objective lenses supported on the same movable unit onto the recording surface of the optical disk.

### DISCLOSURE OF THE INVENTION

### Problems to be Solved by the Invention

When an optical beam is condensed onto a recording surface of an optical disk by an objective lens, a deviation on the optical axis of the convergence position between light passing through a center part of the objective lens and light passing through a peripheral part, that is, spherical aberration occurs. Due to the spherical aberration, the condensed spot diameter of an optical beam increases, and the energy amount of the optical beam per unit area on the spot decreases, so that proper recording and playback of information to/from the optical disk is disturbed. Since the spherical aberration fluctuates according to an error in thickness of the base and a protection layer of the optical disk transmitting an optical beam, even if an optical system is constructed so as to correct the spherical aberration in accordance with a specific thickness in the specifications, unless otherwise the thickness error is dynamically corrected, the spherical aberration cannot be suppressed. However, the optical pickup device of Japanese Unexamined Patent Application Publication No. 2000-048373 does not have a mechanism for dynamically correcting the spherical aberration. One of the reasons is that a compatible recording format of the optical pickup device is a CD and a DVD which are currently spread. Specifically, the fluctuation amount of the spherical aberration is proportional to the fourth power of the numerical aperture of the objective lens. A CD and a DVD do no require a large numerical aperture to an extent that fluctuations of the spherical aberration caused by a thickness error of the base become an issue.

However, to improve recording density and transfer speed of an optical disk (for example, the BD), as compared with the conventional optical disk such as DVD and CD, the size of a pit formed in the optical disk has to be reduced and the rotation speed of the optical disk has to be improved. In recent years, improvement in speed of recording to an optical disk is also a task. In such circumstances, it is necessary to reduce the diameter of a condensed spot of an optical beam emitted onto an optical disk by improving the numerical aperture of an objective lens mounted in an optical pickup device and also to improve the energy amount of the optical beam on the spot. Therefore, as the numerical aperture of the objective lens improves, the spherical aberration has to be dynamically corrected.

When it is assumed that recording density of a DVD improves by development of the one-side two-layer recording technique and the like and, in association with the improvement, the recording speed is increased, it is desirable to use an objective lens having large numerical aperture also for a DVD in future. It is expected that an optical pickup device mounted on a compatible recorder also has to correct spherical aberration in correspondence with a plurality of recording formats.

The present invention has been achieved in view of the circumstances, and an object of the invention is to provide an optical pickup device and an information recording/playback apparatus capable of correcting aberration of an optical beam in correspondence with a plurality of recording formats of optical disks while realizing miniaturization of the device and the apparatus and reduction in manufacturing cost.

### Means for Solving the Problems

In order to solve the above problems, one aspect of the present invention relates to an optical pickup device comprising condensing means for condensing an optical beam emitted from a light source onto a recording surface of an optical recording medium in accordance with each of a plurality of different kinds of optical structures in the optical recording medium, and receiving means for receiving reflection light from the recording surface, comprising:

a plurality of optical means disposed on optical axes of the optical beam provided for the plurality of kinds of optical structures and, by being moved in a direction parallel with any of the optical axes, for correcting aberration in the corresponding kind;

holding means for integrally holding the plurality of optical means; and

moving means for moving the holding means so that each of the plurality of optical means moves in a direction parallel with each of the optical axes.

In order to solve the above problems, another aspect of the present invention relates to an information recording/playback apparatus comprising:

the above-mentioned optical pickup device;

driving means for driving the optical pickup device;

control means for controlling recording and playback of information to/from the optical recording medium by controlling the driving means; and

output means for outputting a signal corresponding to a result of light reception in the optical pickup device.

### BRIEF DESCRIPTION OF DRAWINGS

FIG. 1 is a block diagram showing a configuration example of an information recording/playback apparatus RP of a first embodiment.

FIG. 2 is a top view showing a configuration example of the information recording/playback apparatus RP of the first embodiment.

FIG. 3 is a top view showing a configuration example of an information recording/playback apparatus RP2 of a first modification of the first embodiment.

FIG. 4 is a block diagram showing a configuration example of an information recording/playback apparatus RP3 of a second embodiment.

FIG. 5 is a block diagram showing a configuration example of an information recording/playback apparatus RP4 according to a modification of the second embodiment.

FIG. 6 is a block diagram showing a configuration example of an information recording/playback apparatus RP5 according to a third embodiment.

### DESCRIPTION OF REFERENCE NUMERALS

RP, RP2, RP3, RP4, RP5 . . . information recording/playback apparatus
SP . . . signal processor
C . . . controller
D . . . drive circuit
PU, PU2, PU3, PU4, PU5 . . . optical pickup device
AS . . . actuator servo circuit
SS . . . step motor servo circuit
P . . . playback unit
SM . . . spindle motor
DK . . . optical disk

### BEST MODE FOR CARRYING OUT THE INVENTION

Best modes for carrying out the invention will now be described with reference to the drawings. The following embodiments relate to the case where the present invention is applied to an information recording/playback apparatus for recording/playing back data to/from an optical disc compatible with recording formats of CD, DVD and, further, BD.

### 1. FIRST EMBODIMENT

### 1.1 Configuration of First Embodiment

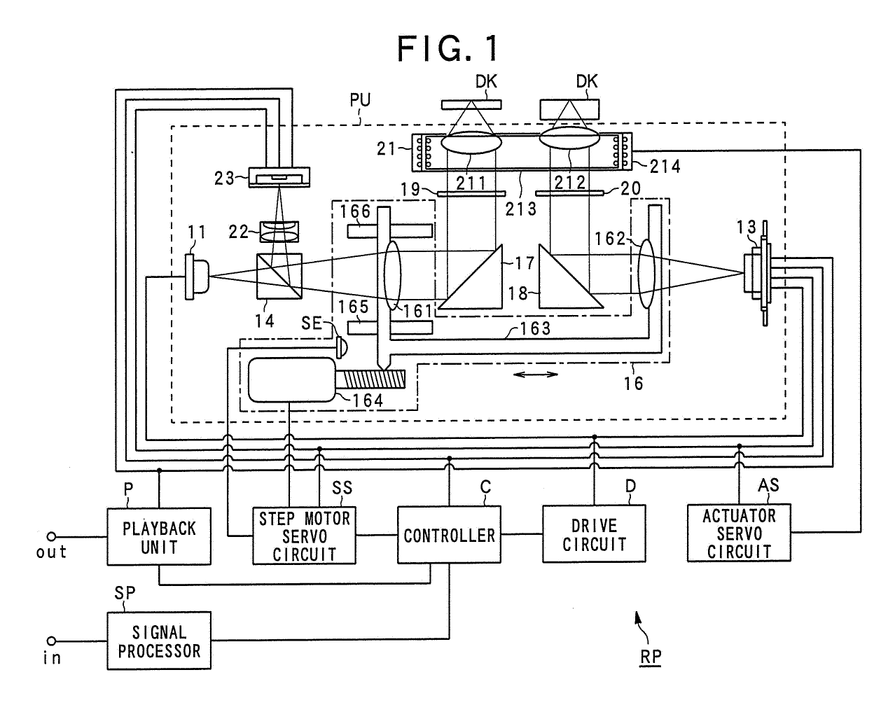

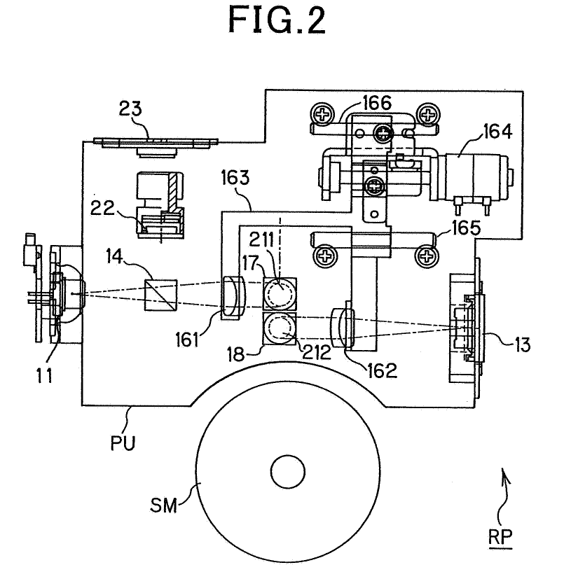

With reference to FIGS. 1 and 2, the general configuration and operation outline of an information recording/playback apparatus RP according to a first embodiment will be described. FIG. 1 is a block diagram showing a configuration example of the information recording/playback apparatus RP of the first embodiment. FIG. 2 is a top view showing a configuration example of the information recording/playback apparatus RP of the first embodiment.

As shown in FIG. 1, the information recording/playback apparatus RP of the first embodiment mainly includes a signal processor SP, a controller C, a drive circuit D, an optical pickup device PU, an actuator servo circuit AS, a step motor servo circuit SS, and a playback unit P.

The signal processor SP has an input terminal, performs signal process on data entered from the outside via the terminal, and outputs the processed data to the controller C. A concrete process performed in the signal processor SP is arbitrary. For example, the signal processor SP may compress input data by a compressing method such as MPEG (Moving Picture Experts Group) and, after that, output the compressed data to the controller C.

The controller C is mainly constructed by a CPU (Central Processing Unit) and controls the components of the information recording/playback apparatus RP. For example, in the case of recording data to an optical disk DK, the controller C outputs a drive signal for recording corresponding to data entered from the signal processor SP to the drive circuit D. On the other hand, in the case of playing back data recorded on the optical disk DK, the controller C outputs a drive signal for reproduction to the drive circuit D.

The drive circuit D is mainly constructed by an amplification circuit, amplifies the drive signal entered from the controller C and, after that, supplies the amplified signal to the optical pickup device PU. The amplification factor in the drive circuit D is controlled by the controller C. In the case of recording data to the optical disk DK, the amplification factor is controlled so that an optical beam is output at recording power (concretely, energy amount causing phase change or coloring matter change in a phase-change optical disk DK (for example, DVD-RW) and an information recording medium of a coloring matter color change type (for example, DVD-R)) from the optical pickup device PU. On the other hand, in the case of playing back data recorded on the optical disk DK, the amplifier factor is controlled so that an optical beam is output at reproduction power (that is, an energy amount causing no change in the coloring matter color change in the optical disk DK).

The optical pickup device PU is used to emit an optical beam to the optical disk DK compatible with a plurality of recording formats (specifically, BD, DVD, and CD) on the basis of a control signal supplied from the drive circuit D and record/read data to/from the optical disk DK. To realize the function, in the embodiment, the optical pickup device PU has, for example, an LD (Laser Diode) 11 outputting an optical beam (wavelength 405 nm) for BD, an optical module 13 outputting an optical beam corresponding to two wavelengths (780 nm and 660 nm) for CD and DVD, a PBS (Polarized Beam Splitter) 14, an aberration correcting mechanism 16, reflecting mirrors 17 and 18, λ/4 plates 19 and 20, an actuator 21 having objective lenses 211 and 212, an error detection lens 22, and an OEIC (Opto-Electronic Integrated Circuit) 23. The optical pickup device PU condenses the optical beam output from the LD 11 onto the objective lens 211, and guides an optical beam output from the optical module 13 to the CD- and DVD-compatible objective lens 212.

The LD (Laser Diode) 11 outputs an optical beam having the wavelength 405 nm on the basis of a drive signal supplied from the drive circuit D. In the embodiment, as will be described below, the optical path has to be separated by the PBS 14 into an outward path (that is, the direction of guiding the optical beam output from a light source to the optical disk DK) and a return path (that is, the direction of guiding reflection light to the OEIC 23 by the optical disk DK). Consequently, as the optical beam output from the LD 11, an optical beam linearly polarized in a predetermined direction (for example, P-polarized) has to be used.

The optical module 13 is constructed by, for example, a laser diode, a photodiode, and a PBS. The optical module 13 outputs an optical beam having wavelengths 780 nm and 660 nm on the basis of the drive signal supplied from the drive circuit D, receives reflection light passed through a collimator lens 162, and outputs the reception signal to the controller C, playback unit P, actuator servo circuit AS, and step motor servo circuit SS.

The PBS 14 transmits the optical beam linearly polarized (for example, P-polarized) and, on the other hand, reflects the optical beam linearly polarized in a direction (for example, S-polarized) different from that of the P-polarized optical beam only by π/2.

The aberration correcting mechanism 16 is an element provided to perform aberration correction on the optical beam incident from the LD 11 and the optical module 13 and the reflection light from the optical disk DK. The aberration correcting mechanism 16 has a collimator lens for converting the incident optical beam passing through the PBS 14 into parallel rays, a collimator lens for converting the optical beam entering from the optical module 13, a lens holder 163 for integrally fixing the collimator lenses, and a step motor 164. The lens holder 163 as a component of the aberration correcting mechanism 16 fixes the collimator lenses so that the optical axes of the collimator lenses 161 and 162 become parallel with each other. The lens holder 163 is supported so as to be movable in parallel with the optical axis direction by a main shaft 165 and an accessory shaft 166. As the step motor 164 is driven to rotate on the basis of the drive signal supplied from the step motor servo circuit SS, the lens holder 163 moves in parallel in the optical axis direction. With such a mechanism, the collimator lenses 161 and 162 move, outgoing light fluxes of the collimator lenses 161 and 162 become diffused or converged light, and the diffused or converged light enters the objective lenses 211 and 212. In such a manner, a spherical aberration correcting mechanism is realized.

The λ/4 plates 19 and 20 mutually convert between linear polarization and circular polarization. By the function of the λ/4 plates 19 and 20, the polarization direction changes only by π/2 between the outward and return paths, and the path is separated to the outward and return paths by the PBS 14.

The actuator 21 has the objective lenses 211 and 212, an objective lens holder 213 to which the objective lenses 212 and 212 are fixed, and a movable mechanism 214 for integrally moving the objective lens holder 213. The actuator 21 changes the position of the objective lenses on the basis of a correction signal supplied from the actuator servo circuit AS, thereby realizing tracking servo and focusing servo. In the embodiment, as shown in FIG. 2, the objective lenses 211 and 212 are disposed in the radius direction of the optical disk DK.

The error detection lens 22 condenses reflection light from the optical disk DK reflected by the PBS 14 to the OEIC 23. The OEIC 23 is constructed by, for example, a photodiode, receives an optical beam incident from the error detection lens 22, and outputs the reception signal to the controller C, playback unit P, actuator servo circuit AS, and step motor servo circuit SS.

Next, the playback unit P has, for example, an adder and an amplifier and generates a playback RF signal on the basis of the reception signals supplied from the optical module 13 and the OEIC 23. The playback unit P performs a predetermined signal process on the playback RF signal and, after that, outputs the processed signal to an output terminal OUT.

The actuator servo circuit AS is constructed by an arithmetic circuit, generates correction signals (concretely, a tracking error signal and a focus error signal) on the basis of the reception signals supplied from the optical module 13 and the OEIC 23 in the optical pickup device PU, and outputs the correction signals to the actuator 21. In the actuator 21, the position of the objective lens holder 213 is changed on the basis of the correction signal, thereby performing tracking servo and focusing servo.

A concrete method for realizing tracking servo and focusing servo is arbitrary. For example, as a method of tracking servo, a DPP (Differential Push Pull) method, a heterodyne method and, further, a 3-beam method can be used. In the case of employing the 3-beam method, it is sufficient to provide the optical module 13 and the OEIC 23 with a receiving unit for receiving a side beam (+primary beam), and provide a grating between the LD and the PBS 14 and in the optical module 13, thereby making the optical beams from the objective lenses 211 and 212 three beams (0-th-order light and ±1st-order light). As a method of focusing servo, for example, astigmatism and a spot-size method can be employed. In the case of employing the astigmatism method, it is sufficient to use a cylindrical lens as the detection lens 22. In the case of employing the spot-size method, it is sufficient to divide reflection light into halves by using a hologram lens as the detection lens 22.

The step motor servo circuit SS is constructed by a not-shown arithmetic circuit and a recording memory and drives the step motor 164 on the basis of detection signals from various sensors provided for the sensor SE (for example, a position sensor for obtaining position information of the collimator 151 and an initial position) and signals supplied from the OEIC 20 and the signal processor SP and necessary to perform spherical aberration correction (for example, an envelope signal, a spherical aberration error signal, a jitter, and the like). By the function of the step motor servo circuit SS, in the information recording/playback apparatus RP of the embodiment, correction of aberration occurring on an optical path of the optical pickup device PU is realized.

A method employed when the step motor servo circuit SS actually drives the step motor 164 is arbitrary. For example, correction values corresponding to the signal values of a detection signal from the sensor SE and an envelope signal may be held in the form of a table on a not-shown memory and the step motor 164 may be driven on the basis of the table.

### 1.2 Operation of First Embodiment

Concrete operation of the information recording/playback apparatus RP of the embodiment having such a configuration will now be described. Since the operation in the information recording/playback apparatus RP in the case (1) where a BD is used as the optical disk DK and that in the case (2) where a CD or DVD is used as the optical disk DK are different from each other, each of the cases will be described.

(1) Case where BD is Used as Optical Disk DK

In the case where a BD is inserted as the optical disk DK into the information recording/playback apparatus RP, a not-shown disk discriminating circuit detects that an optical disk to be played back is a BD. In this state, the user performs an input operation of recording or playing back information from the optical disk DK with a not-shown operating unit. In response to the input operation, the controller C starts supplying a drive signal to the drive circuit D. In the case where the operation instructs recording of information, the controller C supplies a drive signal corresponding to a signal supplied from the signal processor SP to the drive circuit D and sets the amplification factor in the drive circuit D to a value corresponding to the recording power. In the case where the operation instructs reproduction of information, the controller C supplies a drive signal for playback to the drive circuit D and sets the amplification factor in the drive circuit D to a value corresponding to the playback power.

When the drive signal is supplied from the controller C in such a manner, the drive circuit D outputs a predetermined drive signal to the LD 11. As a result, an optical beam having the wavelength of 405 nm (for example, p-polarized light) is output from the LD 11. The optical beam passes through the PBS 14 and enters the collimator lens 161 of the aberration correcting mechanism 16. The optical beam is converted to parallel rays by the collimator lens 161 and, after that, reflected upward in the drawing by the reflecting mirror 17. Subsequently, the optical beam passes through the λ/4 plate 19, thereby being changed to circularly polarized light. The circularly polarized light enters the objective lens 211 and is incident on the recording surface of the optical disk DK.

The optical beam incident on the recording surface of the optical disk DK is reflected by the recording surface. The reflection light passes through the objective lens 211 and passes through the λ/4 plate 19 again. As a result, the polarization direction changes from that in the outward path only by π/2. For example, the optical beam which is p-polarized in the outward path becomes an optical beam which is s-polarized in the return path. As a result, the reflection light passed through the λ/4 plate 19 is reflected to the left in the drawing by the reflecting mirror 17. The reflection light passes through the collimator lens 161 and is reflected by the PBS 14 and condensed by the error detection lens 22 to the OEIC 23.

When the reflection light condensed as described above is received, the OEIC 23 outputs the reception signal corresponding to the reflection light to the playback unit P, the controller C and, further, the actuator servo circuit AS and the step motor servo circuit SS. As a result, for example, at the time of playback, a signal corresponding to information recorded on the optical disk is output from the playback unit P. For example, the amplification factor of the drive circuit D is controlled by the controller C and the light amount of the optical beam output from the LD 11 is controlled. The actuator 21 is driven by the actuator servo circuit AS, thereby realizing the tracking servo and the focusing servo. Further, the step motor 164 is driven by the step motor servo circuit SS, thereby realizing aberration correction.

(2) Case where CD and DVD are Used as Optical Disk DK

On the other hand, in the case where the optical disk DK to be played back is a CD or DVD, the drive circuit D outputs a predetermined drive signal to the optical module 13 on the basis of the drive signal supplied from the controller C. As a result, an optical beam (for example, s-polarized light) having the wavelength 660 nm or 780 nm is output from the optical module 13, and the optical beam enters the collimator lens 162 of the aberration correcting mechanism 16. The optical beam is converted to parallel rays by the collimator lens 162 and, after that, reflected upward in the drawing by the reflecting mirror 18. Subsequently, the optical beam passes through the λ/4 plate 20, thereby being changed to circularly polarized light. The resultant light enters the objective lens 212 and is incident on the recording surface of the optical disk DK.

The optical beam incident on the recording surface of the optical disk DK is reflected by the recording surface, passes as the reflection light through the objective lens 212 and, after that, passes through the λ/4 plate 20 again. As a result, the polarization direction changes from that in the outward path only by π/2 and is reflected to the right in the drawing by the reflecting mirror 18. The reflection light is condensed by the collimator lens 162 to the optical module 13. As a result, the reflection light is received by the optical module 13. In such a manner, tracking servo or the like is realized.

As described above, in the information recording/playback apparatus RP in the embodiment, the collimator lens 161 is disposed on the optical axis corresponding to the BD. The collimator lens 161 moves in the direction parallel with the optical axis, thereby correcting spherical aberration in accordance with the BD. The collimator lens 162 is disposed on the optical axis corresponding to the CD and DVD. The collimator lens moves in the direction parallel with the optical axis, thereby correcting spherical aberration in accordance with the CD and DVD. The lens holder 163 integrally holds the collimator lenses, and the step motor 164 moves the lens holder 163 so that the collimator lenses 161 and move in the direction parallel with the optical axis. With the configuration, aberration correction compatible with BD, CD, and DVD can be realized by a single step motor. Consequently, while realizing miniaturization of the apparatus and reduction in manufacturing cost, aberration of an optical beam can be corrected in correspondence with a plurality of recording formats of an optical disk.

The peripheral intensity and use efficiency of the optical beam emitted to the BD is determined by the focal length of the collimator lens 161, and the peripheral intensity and use efficiency of the optical beam emitted to CD and DVD is determined by the focal length of the collimator lens 162. Thus, optimum conditions can be set for each of a plurality of recording formats with respect to the peripheral intensity and use efficiency of an optical beam.

For example, to record/playback information to/from the optical disk DK having high recording density such as BD at high speed, to increase the intensity of an optical beam emitted to the optical disk DK is enhanced and, desirably, intensity distribution of the optical beam is maintained as uniformly as possible. However, the intensity of an outgoing optical beam from the LD has the Gaussian distribution using the optical axis as a center. When an optical beam is taken to the tail part of the Gaussian-distributed energy curve in order to enhance the intensity of the optical beam, the light intensity in the peripheral part decreases. By increasing an output of the LD 11 and setting the focal length of the collimator lens 161 to be long, the optical beam irradiated on the optical disk DK is narrowed and the peripheral intensity of the optical beam can be increased. On the other hand, for a CD and a DVD, it is desirable to increase the use efficiency more than the peripheral intensity of the optical beam. By setting the focal length of the collimator lens 162 to be shorter than that of the collimator lens 161, a larger amount of the optical beam can be taken.

In the information recording/playback apparatus RP of the embodiment, the collimator lenses 161 and 162 are held by the lens holder 163 so that the optical axes of the collimator lenses 161 and 162 become parallel with each other. Consequently, since spherical aberration can be corrected in the collimator lenses 161 and 162 only by moving the lens holder 163 in the lateral directions of the drawing, the step motor 164 can employ a simple driving method.

In the embodiment, the objective lenses 212 and 213 are arranged in the radial direction of the optical disk DK, so that a simple control method can be employed to realize tracking servo. For example, in the case of employing the three-beam method for tracking servo, when the objective lens is apart from the radial direction of the optical disk DK, axial deviation of the +primary light of the optical beam emitted from the objective lens occurs due to variations in the travel direction of tracks in the inner and outer radius of the optical disk DK. Therefore, a mechanism for controlling the axial deviation is necessary. In contrast, in the embodiment, the objective lenses 212 and 213 are disposed in the radial direction, so that such axial deviation does not occur, and the simple control method can be employed.

The case of realizing the BD-, DVD-, and CD-compatible recorder has been described as an example in the foregoing first embodiment. For example, the information recording/playback apparatus RP for recording and playing back information to/from various optical disks DK of different formats such as an HDDVD-(registered trademark), DVD-, and CD-compatible player can be also realized with a configuration similar to that of the first embodiment.

In the first embodiment, the compatible recorder for recording and playing back information to/from the optical disk DK compatible with three recording formats of BD, DVD, and CD has been described as an example. For example, a compatible recorder for recording/playing back information to/from an optical disk DK compatible with two recording formats (BD and CD, BD and DVD, or DVD and CD) can be also realized with a similar configuration.

Further, the example of constructing the controller C and the drive circuit D by devices such as the CPU separate from the optical pickup device PU in the information recording/playback apparatus RP of the first embodiment has been described. The separate devices may be formed integrally with the optical pickup device PU.

### 1.3 First Modification of First Embodiment

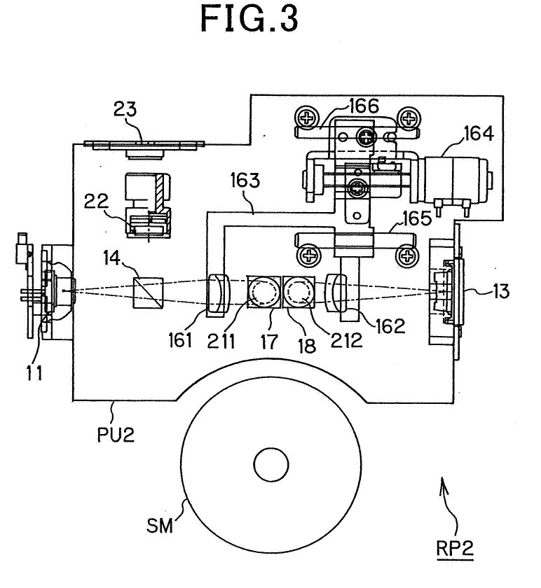

Next, a first modification of the first embodiment will be described with reference to FIG. 3. FIG. 3 is a top view showing a configuration example of an information recording/playback apparatus RP2 of the modification. In FIG. 3, the same reference numerals are designated to the same elements as those of FIG. 2.

Although the objective lenses 212 and 213 are arranged along the radial direction of the optical disk DK in the foregoing first embodiment, the invention is not limited to the configuration. As shown in FIG. 3, the objective lenses 212 and 213 may be disposed so as to be in parallel with any of tangential directions in the optical disk DK.

Since the other configurations and operations are similar to those of the first embodiment, detailed description will not be repeated.

As described above, with the configuration of the modification, effects similar to those of the first embodiment can be produced, and each of the objective lenses 212 and 213 can be easily moved to the innermost radius of the optical disk DK.

### 1.4 Second Modification of First Embodiment

A second modification of the first embodiment of the present invention will be described.

Although the lens holder 163 is moved by screw-feeding by the rotation of the step motor 164 in the aberration correcting mechanism 16 of the first embodiment, the present invention is not limited to the method but other methods capable of physically moving the lens holder can be also employed.

For example, the lens holder 163 is fixed to the casing of the optical pickup device PU by a plate spring, suspension wire, or the like. The lens holder 163 is moved by electromagnetic force generated by a moving-coil-type motor to move the collimator lenses 161 and 162 in parallel with the optical axis direction, thereby enabling aberration to be corrected.

### 2. SECOND EMBODIMENT

### 2.1 Configuration and Operation of Second Embodiment

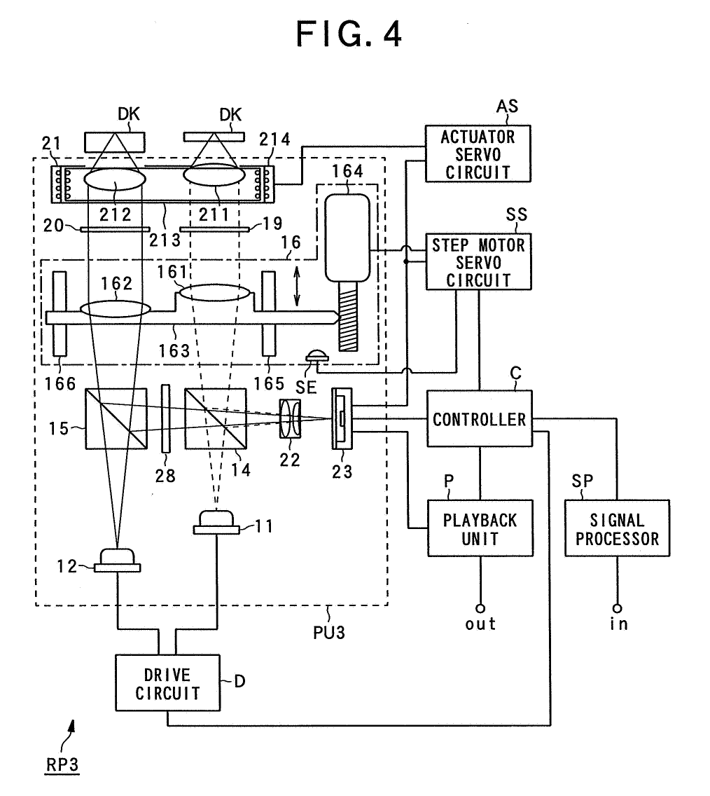

Next, an information recording/playback apparatus RP3 as a second embodiment of the present invention will be described with reference to FIG. 4. FIG. 4 is a block diagram showing a configuration example of the information recording/playback apparatus RP3 of the second embodiment. In FIG. 4, the same reference numerals are designated to the same elements as those of FIG. 1.

In the foregoing first embodiment, the travel directions of optical beams incident on the collimator lenses 161 and 162 are opposite to each other. In the second embodiment described below, the travel directions of optical beams incident on the collimator lenses 161 and 162 are the same. Although the optical module 13 emits optical beams to a CD and a DVD and receives reflection light in the first embodiment, in the second embodiment, the LD 12 emits optical beams to a CD and a DVD and the OEIC 23 receive reflection light from a BD, the CD, and the DVD.

The LD 12 is constructed by two laser diodes and outputs optical beams having wavelengths 780 nm and 660 nm. Since the path is divided to an outward path and a return path, as the optical beam output from the LD 12, optical beams each linearly polarized in a predetermined direction have to be used.

Like the PBS 14, a PBS 15 transmits an optical beam linearly polarized in a predetermined direction and reflects an optical beam linearly polarized in a direction different from the optical beam only by π/2.

A λ/2 plate 28 converts the polarization direction of the linearly polarized optical beam from S-polarization to P-polarization or from P-polarization to S-polarization. By the function of the λ/2 plate 28, the optical beam emitted from the LD 12 transmits the PBS 14 in the return path and is received by the OEIC 23.

The lens holder 163 of the aberration correcting mechanism 16 of the embodiment holds the collimator lenses 161 and 162 so that the travel directions of optical beams entering the collimator lenses 161 and 162 coincide with each other.

Concrete operation of the information recording/playback apparatus RP3 of the second embodiment having such a configuration will be described.

(1) Case where BD is Used as Optical Disk DK

First, in the case where the optical disk DK to be played back is a BD, the drive circuit D outputs a predetermined drive signal to the LD 11 on the basis of the drive signal supplied from the controller C. As a result, an optical beam (for example, p-polarized light) having the wavelength of 405 nm is output from the LD 11. The optical beam passes through the PBS 14 and enters the collimator lens 161 of the aberration correcting mechanism 16. The optical beam is converted to parallel rays by the collimator lens 161 and the parallel rays pass through the λ/4 plate 19, thereby changing to circularly polarized light. The circularly polarized light enters the objective lens 211 and falls on the recording surface of the optical disk DK.

The optical beam incident on the recording surface of the optical disk DK in such a manner is reflected by the recording surface. The reflection light passes through the objective lens 211 and again the λ/4 plate 19. In such a manner, the optical beam which is, for example, p-polarized in the outward path becomes an s-polarized optical beam in the return path. As a result, the reflection light passed through the λ/4 plate 19 transmits the collimator lens 161, is reflected by the PBS 14, condensed by the error detection lens 22 to the OEIC 23, and received by the OEIC 23.

(2) Case where CD and DVD are Used as Optical Disk DK

On the other hand, in the case where the optical disk DK to be played back is a CD or DVD, the drive circuit D outputs a predetermined drive signal to the LD 12 on the basis of the drive signal supplied from the controller C. As a result, an optical beam (for example, p-polarized light) having the wavelength 660 nm or 780 nm is output from the LD 12, and the optical beam passes through the PBS 15 and enters the collimator lens 162 of the aberration correcting mechanism 16. The optical beam is converted to parallel rays by the collimator lens 162. The parallel rays pass through the λ/4 plate 20, thereby being changed to circularly polarized light. The resultant light enters the objective lens 212 and is incident on the recording surface of the optical disk DK.

The optical beam incident on the recording surface of the optical disk DK is reflected by the recording surface. The reflection light passes through the objective lens 212 and, after that, passes through the λ/4 plate 20 again. The optical beam which is, for example, p-polarized in the outward path becomes the optical beam which is s-polarized in the return path. As a result, the reflection light passed through the λ/4 plate 20 passes through the collimator lens 162 and is reflected to the right in the drawing by the PBS 15. By passing through the λ/2 plate 28, for example, the s-polarized reflection light becomes p-polarized light. As a result, the reflection light that passed through the λ/2 plate 28 passes through the PBS 14, is condensed by the error detection lens 22 to the OEIC 23, and is received by the OEIC 23.

As described above, in the information recording/playback apparatus RP3 in the second embodiment, in addition to the effects produced by the operation of the information recording/playback apparatus RP of the first embodiment, the travel directions of optical beams entering the collimator lenses 161 and 162 are made coincide with each other. It is therefore easy to make the optical path of reflection light in the case where the disk DK is a BD and that in the case where the disk DK is a CD or DVD coincide with each other. Thus, a single error detection lens and a single OEIC can cope with a plurality of recording formats and, further miniaturization of the apparatus and reduction in manufacturing cost can be realized.

Although optical beams are emitted from two light sources (LDs 11 and 12) compatible with BD and CD and DVD in the second embodiment, optical beams having three wavelengths adapted to BD, CD, and DVD can be emitted from a single light source. In this case, for example, a dichroic mirror is disposed on the optical path extending from the light source to the PBS 15. An optical beam having a wavelength of 450 nm or larger passes through the dichroic mirror and is guided to the PBS 15. On the other hand, an optical beam having a wavelength less than 450 nm is reflected to the right, and the reflected optical beam is reflected upward in the drawing by a mirror and is guided to the PBS 14.

### 2.2 Modification of Second Embodiment

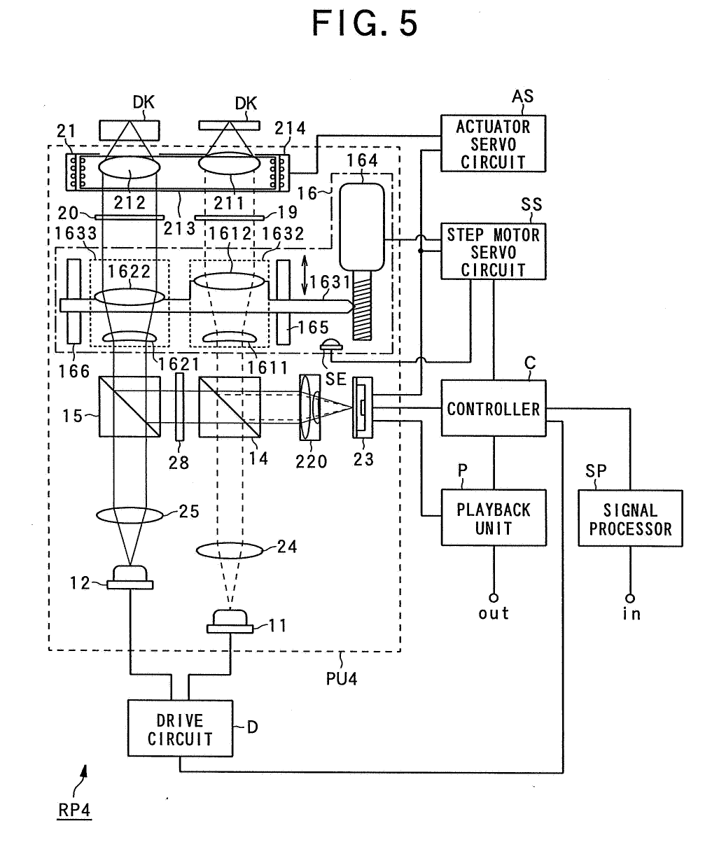

A modification of the second embodiment of the invention will now be described with reference to FIG. 5. FIG. 5 is a block diagram showing a configuration example of an information recording/playback apparatus RP4 of the modification. In FIG. 5, the same reference numerals are designated to the same elements as those of FIG. 4.

Although the method of correcting aberration by moving the collimator lenses 161 and 162 is employed in the second embodiment, the invention is not limited to the method. A method of correcting aberration by a beam expander can be also employed.

The aberration correcting mechanism 16 of the modification is provided with lens holders 1632 and 1633 unmovably fixed to the casing of an optical pickup device PU4, and a lens holder 1631 supported by the main shaft and the accessory shaft 166 so as to be movable in parallel with the optical axis direction and moved according to the rotation of the step motor 164. First lenses 1611 and 1621 as concave lenses are fixed to the lens holders 1632 and 1633, and second lenses 1612 and 1622 as convex lenses are fixed to the lens holder 1631 in positions apart from the first lenses 1611 and 1621 only by a predetermined distance.

The information recording/playback apparatus RP4 employs the configuration that an optical beam emitted from the LD 11 is converted by the collimator lens 24 to parallel rays and the parallel rays enter the lens 1611. The sectional area of the optical beam as parallel rays incident on the first lens 1611 is expanded by the action of the first and second lenses 1611 and 1612, and the resultant beam goes out (in other words, the first and second lenses 1611 and 1612 function as a so-called beam expander). With such a configuration, by moving the fixed lens holder 1631 of the second lens 1612 in parallel with the optical axis direction to change the distance between the lenses 1611 and 1612, outgoing light as parallel rays can be continuously changed from diverging light to convergent light. As a result, the aberration correcting mechanism by the lenses 1611 and 1612 can be realized. Aberration correction is similarly performed on the optical beam output from the LD 12 in a manner similar to the case of the LD 11.

In the configuration example of FIG. 5, attention has to be paid to the point that since the optical beam incident on the error detection lens 220 is not convergent light but parallel rays, different from the first embodiment, a collimator lens has to be provided. Since the other configuration is similar to that of the first embodiment, the details will not be described.

With the configuration as described above, also in the case of employing the beam expander in the aberration correcting mechanism 16, effects similar to those of the second embodiment can be produced.

Since the cross section of the optical beam is expanded by the aberration correcting mechanism 16, by reducing the diameter of an optical beam entering the first lenses 1611 and 1621, a part on the optical path from the light source to the beam expander can be miniaturized.

Further, the peripheral intensity and the use efficiency of the optical beam is determined by the focal length of the collimator lens 24 or 25, and the correction sensitivity of spherical aberration (correction sensitivity in this case denotes an amount of correction aberration relative to a predetermined movement amount of the second lens 1612 or 1622) is determined by the magnifying power of the first lens 1611 of the aberration correcting mechanism 16 and the numerical aperture of the objective lens 211, or the magnifying power of the first lens 1621 and the numerical aperture of the objective lens 212. Consequently, the correction sensitivity of spherical aberration can be freely adjusted independently of the peripheral intensity and use efficiency, and flexibility in product design improves.

The case of correcting the spherical aberration by using the beam expander has been described above. Also in the configuration where the cross section of a beam is reduced by the first lens and the resultant light is converted to parallel rays by the second lens, spherical aberration can be corrected in a manner similar to the second embodiment.

### 3. THIRD EMBODIMENT

### 3.1 Configuration and Operation of Third Embodiment

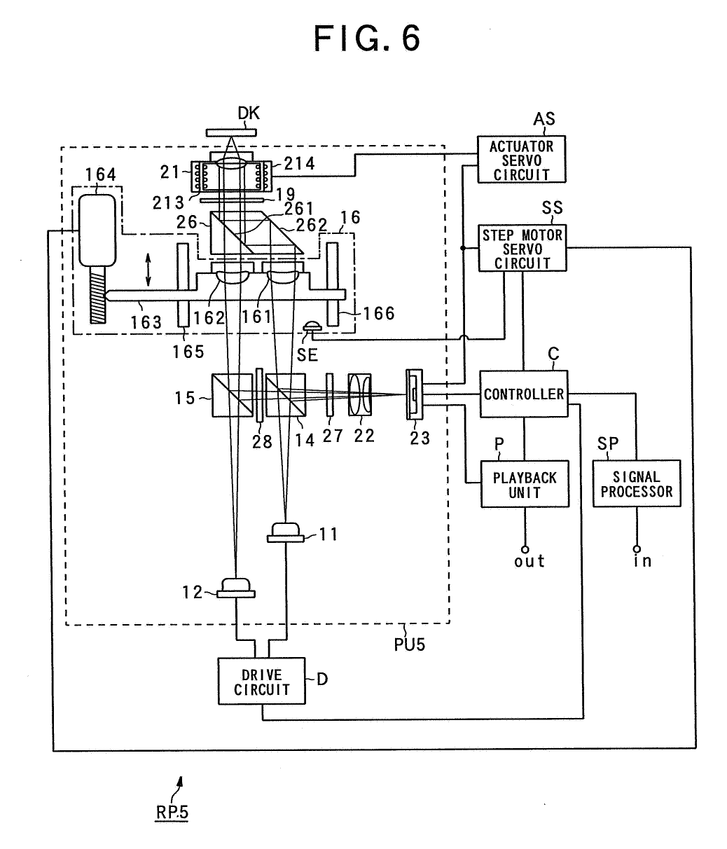

Next, an information recording/playback apparatus RP5 as a third embodiment of the present invention will be described with reference to FIG. 6. FIG. 6 is a block diagram showing a configuration example of the information recording/playback apparatus RP5 of the third embodiment. In FIG. 6, the same reference numerals are designated to the same elements as those of FIG. 4.

In the foregoing second embodiment, in the case where the optical disk DK is a BD, an optical beam is condensed by the objective lens 211. In the case where the optical disk DK is a CD or DVD, an optical beam is condensed by the objective lens 212. In the third embodiment described below, two optical paths are set as a single optical path by a light guide 26 to guide an optical beam to a compatible objective lens 2110. By using the single compatible objective lens, the optical beam is condensed.

To realize such a function, the light guide 26 has a mirror 261 and a dichroic mirror 262.

Among the elements, the dichroic mirror 262 is provided on the optical path from the collimator lens of the aberration correcting mechanism 16 to the λ/4 plate. The dichroic mirror 262, for example, transmits an optical beam having a predetermined wavelength (for example, 450 nm) or longer and reflects an optical beam having a wavelength less than the predetermined wavelength.

The compatible objective lens 2110 is an objective lens compatible with BD, CD, and DVD. For an optical beam emitted from the LD 11 and passing through the peripheral part of the lens, the compatible objective lens 2110 functions as an objective lens having a numerical aperture of 0.85. For an optical beam emitted from the LD 12 and passing through the inner part of the lens, the compatible objective lens 2110 functions as an objective lens having a numerical aperture of 0.6.

Concrete operation of the information recording/playback apparatus RP5 of the embodiment having a such configuration will be described.

(1) Case where BD is Used as Optical Disk DK

First, in the case where the optical disk DK to be played back is a BD, the drive circuit C outputs a predetermined drive signal to the LD 11 on the basis of the drive signal supplied from the controller C. As a result, an optical beam (for example, p-polarized light) having the wavelength of 405 nm is output from the LD 11. The optical beam passes through the PBS 14 and enters the collimator lens 161 of the aberration correcting mechanism 16. The optical beam is converted to parallel rays by the collimator lens 161 and the parallel rays are reflected to the left in the drawing by the mirror 261 and, after that, reflected upward in the drawing by the dichroic mirror 262. Subsequently, the optical beam is polarized by the λ/4 plate 19 to circularly polarized light. The circularly polarized light falls on the recording surface of the optical disk DK via the compatible objective lens 2110.

The optical beam incident on the recording surface of the optical disk DK in such a manner is reflected by the recording surface. The reflection light passes through the compatible objective lens 2110 and then the λ/4 plate 16. In such a manner, the optical beam becomes light whose polarization direction is changed from that in the outward path only by π/2 (for example, s-polarized light). Subsequently, the optical beam is reflected to the right in the drawing by the dichroic mirror 262 and is reflected downward in the drawing by the mirror 261. The reflection light passed through the collimator lens and enters the PBS 14. After that, the reflection light is reflected by the PBS 14, passes through a grating 27 for positioning and, after that, is condensed by the error detection lens 22 to the OEIC 23.

(2) Case where CD and DVD are Used as Optical Disk DK

On the other hand, in the case where the optical disk DK to be played back is a CD or DVD, the drive circuit D outputs a predetermined drive signal to the LD 12 on the basis of the drive signal supplied from the controller C. As a result, an optical beam (for example, p-polarized light) having the wavelength 660 nm or 780 nm is output from the LD 12, and the optical beam passes through the PBS 15 and enters the collimator lens 162 of the aberration correcting mechanism 16. The optical beam is converted to parallel rays by the collimator lens 162, and the parallel rays pass through the dichroic mirror 262. Subsequently, the optical beam is polarized by the λ/4 plate 19 to circularly polarized light. The resultant light enters the compatible objective lens 2110 and is incident on the recording surface of the optical disk DK.

The optical beam incident on the recording surface of the optical disk DK is reflected by the recording surface. The reflection light passes through the compatible objective lens 2110 and, after that, passes through the λ/4 plate 16. The optical beam is converted to an optical beam (for example, s-polarized light) whose polarization direction changes from that in the outward path only by π/2. Subsequently, the optical beam passes through the dichroic mirror 262 and the collimator lens 162 and is reflected to the right in the drawing by the PBS 15. By passing through the λ/2 plate 28, for example, the s-polarized reflection light becomes p-polarized light. As a result, the reflection light that passed through the λ/2 plate 28 passes through the PBS 14 and a grating 27 for positioning and, after that, is condensed by the error detection lens 22 to the OEIC 23.

As described above, in the information recording/playback apparatus RP5 in the embodiment, in addition to the effects produced by the operation of the information recording/playback apparatus RP3 of the second embodiment, by the light guide 26, the optical axes of optical beams passing through the collimator lenses 161 and 162 of the aberration correcting mechanism 16 are made coincide with each other and guided to the compatible objective lens 2110, and reflection light is guided to the collimator lenses 161 and 162. Consequently, even in the case of using one compatible objective lens 2110, aberration of the optical beam can be corrected in correspondence with a plurality of recording formats of an optical disk. Thus, further miniaturization of the apparatus and reduction in manufacturing cost can be realized.

The present invention is not limited to the foregoing embodiments. The embodiments are illustrative and any apparatus having substantially the same configuration as that of the technical ideas described in the scope of claims of the present invention and producing similar effects is included in the technical scope of the present invention.

All of the disclosure of Japanese Patent Application No. 2005-096609 including the specification, the scope of claims, drawings, and abstract filed on Mar. 30, 2005 is hereby incorporated by reference.

1-10. (canceled)

11. An optical pickup device comprising a condensing device which condenses an optical beam emitted from a light source onto a recording surface of an optical recording medium in accordance with each of a plurality of different kinds of optical structures in the optical recording medium, and a receiving device which receives reflection light from the recording surface, comprising:
a plurality of optical devices disposed on optical axes of the optical beam provided for the plurality of kinds of optical structures and, by being moved in a direction parallel with any of the optical axes, which correct aberration in the corresponding kind;
a holding device which integrally holds the plurality of optical devices; and
a moving device which moves the holding device so that each of the plurality of optical devices moves in a direction parallel with each of the optical axes,
wherein the higher relative recording density of any of the plurality of kinds of the optical structures is, the longer relative focal length of the optical device corresponding to the kind is.

12. The optical pickup device according to claim 11,
wherein at least one of the plurality of optical devices is a collimator lens for converting the incident optical beam to parallel rays.

13. An optical pickup device comprising a condensing device which condenses an optical beam emitted from a light source onto a recording surface of an optical recording medium in accordance with each of a plurality of different kinds of optical structures in the optical recording medium, and a receiving device which receives reflection light from the recording surface, comprising:
first optical devices each disposed on optical axes of the optical beam provided for the plurality of kinds of optical structures, which convert incident optical beam to parallel rays,
optical devices each provided on optical axes of the optical beam provided for the plurality of kinds of optical structures, each including a second optical device which increases or decreases a sectional area of the optical beam converted to parallel rays by the first optical device, and a third optical device which converts the optical beam whose sectional area is increased or decreased by the second optical device into parallel rays, wherein when any one of the second optical device and third optical device moves in a direction parallel with the optical axis, the optical device corrects aberration in accordance with the kind;
a holding device which integrally holds the one of the optical device; and
a moving device which moves the holding device so that the one of the optical device moves in a direction parallel with the optical axis,
wherein the higher relative recording density of any of the plurality of kinds of the optical structures is, the longer relative focal length of the first optical device corresponding to the kind is.

14. The optical pickup device according to claim 11,
wherein the light source outputs the optical beams having wavelengths corresponding to the kinds.

15. The optical pickup device according to claim 11,
wherein the holding device holds the plurality of the optical devices so that the optical axes of the optical device become parallel with each other.

16. The optical pickup device according to claim 15,
wherein the holding device holds the plurality of the optical devices so that travel directions of the optical beams passing through the optical devices coincide with each other.

17. The optical pickup device according to claim 11,
wherein the optical recording medium has a disc shape,
the condensing device has objective lenses corresponding to the kinds, and
the objective lenses are disposed along the radial direction of the optical recording medium.

18. The optical pickup device according to claim 11,
Wherein the optical recording medium has a disc shape,
the condensing device has objective lenses corresponding to the kinds, and
the objective lenses are disposed so as to be parallel with any of tangential directions in the optical recording medium.

19. The optical pickup device according to claim 11,
further comprising a light guiding device which guides the optical beams passed through the plurality of optical devices to the condensing device while setting the optical axes of the optical beams to the same, and guiding the reflection light to the optical device corresponding to the kinds.

20. An information recording/playback apparatus comprising:
an optical pickup device;
a driving device which drives the optical pickup device;
a control device which controls recording and playback of information to/from the optical recording medium by controlling the driving device; and
an output device which outputs a signal corresponding to a result of light reception in the optical pickup device,
wherein the optical pickup device comprises a condensing device which condenses an optical beam emitted from a light source onto a recording surface of an optical recording medium in accordance with each of a plurality of different kinds of optical structures in the optical recording medium, and a receiving device which receives reflection light from the recording surface, comprising:
a plurality of optical devices disposed on optical axes of the optical beam provided for the plurality of kinds of optical structures and, by being moved in a direction parallel with any of the optical axes, which correct aberration in the corresponding kind;
a holding device which integrally holds the plurality of optical devices; and
a moving device which moves the holding device so that each of the plurality of optical devices moves in a direction parallel with each of the optical axes,
wherein the higher relative recording density of any of the plurality of kinds of the optical structures is, the longer relative focal length of the optical device corresponding to the kind is.
